(19) United States
(12) Patent Application Publication
(10) Pub. No.: US 2008/0319852 A1
(43) Pub. Date: Dec. 25, 2008

(54) Interactive advertisement overlays on full-screen content

(75) Inventors: David Gardner, Covington, WA (US); William H. Vong, Hunts Point, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,770

(22) Filed: Jun. 25, 2007

(51) Int. Cl. G06Q 30/00; G06F 17/30

(52) U.S. Cl. 705/14

(57) ABSTRACT

In accordance with one or more aspects, an interactive advertisement overlay is displayed on a full-screen display of program and/or video commercial content. At the end of display of the video commercial content, the display of the interactive overlay is terminated, and an advertising icon is displayed during a full-screen display of program content. The display of the interactive advertisement overlay is reinstated in response to a user selecting the advertising icon. In accordance with one or more other aspects, program content and video commercial content are displayed on a full-screen display of a display device. An interactive advertisement overlay is also displayed on the full-screen display. The interactive advertisement overlay includes advertising information associated with a sponsor of the program content.

### BACKGROUND

Television advertising has traditionally been passive advertising; commercials are displayed to the user during a program at times chosen by the television program producer or distributor. More recently, some television programs can be played back on a computer. Such computers typically display user interfaces having multiple windows, allowing the television program to be displayed in one window while interactive advertising is displayed in a second window. While such a technique for displaying interactive advertising works in the multi-windowed environment of a computer, problems are encountered when trying to apply the technique to more traditional full-screen television displays because such displays do not use multiple windows.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the interactive advertisement overlays on full-screen content discussed herein, an interactive advertisement overlay is displayed on a full-screen display of video commercial content. At the end of display of the video commercial content, the display of the interactive overlay is terminated, and an advertising icon is displayed during a full-screen display of program content. The display of the interactive advertisement overlay is reinstated in response to a user selecting the advertising icon.

In accordance with one or more aspects of the interactive advertisement overlays on full-screen content discussed herein, program content and video commercial content are displayed on a full-screen display of a display device. An interactive advertisement overlay is also displayed on the full-screen display. The interactive advertisement overlay includes advertising information associated with a sponsor of the program content.

### BRIEF DESCRIPTION OF THE DRAWINGS

The same numbers are used throughout the drawings to reference like features.

FIG. 1 illustrates an example system in which the interactive advertisement overlays on full-screen content can be implemented.

FIG. 2 illustrates an example overlay on a full-screen display.

FIG. 3 illustrates another example overlay with an ad icon on a full-screen display.

FIG. 4 illustrates another example ad icon on a full-screen display.

FIG. 5 is a flowchart illustrating an example process for displaying an interactive advertisement overlay.

FIG. 6 is a flowchart illustrating an example process for displaying an ad icon.

FIG. 7 illustrates an example timeline display of program playback with an advertisement overlay and ad icons.

FIG. 8 illustrates another example timeline display of program playback with an advertisement overlay and ad icons.

FIG. 9 illustrates another example timeline display of program playback with advertisement overlays.

FIG. 10 illustrates an example computer-based device that can implement embodiments of the interactive advertisement overlays on full-screen content discussed herein.

### DETAILED DESCRIPTION

Interactive advertisement overlays on full-screen content are discussed herein. Both program content and commercial content are displayed on a full-screen display. An interactive advertisement overlay is also displayed, and this interactive advertisement overlay can be displayed independent of any user request for the overlay to be displayed. Additionally, an advertisement icon can be displayed during display of the program content and/or the commercial content. The advertisement icon can be selected by a user, and in response to such a selection the interactive advertisement overlay is displayed to the user.

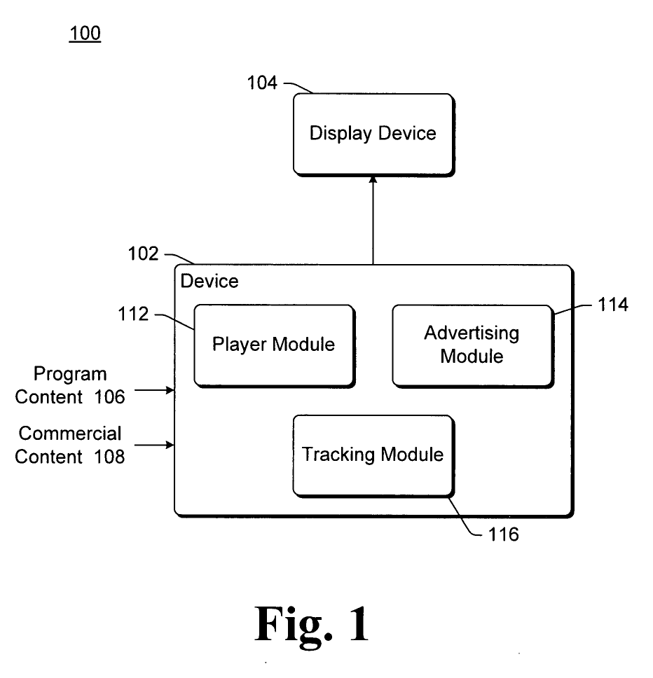

FIG. 1 illustrates an example system 100 in which the interactive advertisement overlays on full-screen content can be implemented. System 100 includes a device 102 and a display device 104. Display device 104 can be any of a variety of different display devices, such as a cathode ray tube (CRT) television, plasma television, liquid crystal display (LCD), projector, and so forth. Device 102 can be any of a variety of different devices for generating a display for device 104, such as a set-top box, game console, digital video recorder, server computer, personal computer, and so forth. Although illustrated as separate in FIG. 1, devices 102 and 104 can be implemented as part of the same device.

Device 102 receives program content 106 and/or commercial content 108 and generates a full-screen display of program content and/or commercial content for display on display device 104. Device 102 can also generate an interactive advertisement (ad) overlay to be displayed on the full-screen display of device 104, and also an interactive ad icon to be displayed on the full-screen display of device 104.

Reference is made herein to commercial (or advertisement) content (or information). The display of commercial content 108 can be interspersed with the display of program content 106 as program content 106 is played back, and is typically displayed full-screen on display device 104. In such situations, the commercial content is typically referred to as a video commercial or video advertisement (although it may alternatively have other types of content in addition to or in place of video, such as audio content). The commercial content 108 can also be included in interactive advertisement overlays and/or interactive ad icons. In such situations, the commercial content is typically referred to as an interactive commercial or interactive advertisement. Interactive commercials and video commercials are typically different content presented to tile user, although the content can alternatively be the same.

Content 106 and 108 can be received from any of a variety of sources over any of a variety of media, such as satellite signals, cable signals, broadcast signals, network (e.g., Internet) packets, removable media (e.g., DVD),.local storage (e.g., a local hard drive of device 102 or 104), and so forth. Program content 106 and commercial content 108 can be received from the same source over the same medium, or alternatively can be received from different sources and/or over different media.

Program content 106 includes any of a variety of different audio/video content, such as television programs, movies, news broadcasts, and so forth. The particular program content 106 to be displayed is typically determined by a user request, such as a selection of particular content from a programming guide, selection of a particular channel to be tuned to, and so forth. Commercial content 108 includes commercials that are displayed on display device 104 interspersed among the display of the program content 106. Commercial content 108 can be received interspersed with program content 106 (e.g., a television program can be broadcast with program content 106 and interspersed commercial content 108 over the same channel). Alternatively, commercial content 108 can be received separately from program content 106, such as over a separate channel.

Display device 104 displays program and/or commercial content (as well as any ad overlays and ad icons) on a full-screen display. The full-screen display uses most, if not all, of the area available on device 104 for the display of visual content. The full-screen display does not use multiple different windows as are commonly used in modern computing devices. It is to be appreciated, however, that a full-screen display may not use some portions of the area available on device 104 for the display of visual content. For example, content may be displayed in a letterbox format with blank portions at the top and bottom of the screen. Content may also be displayed in other aspect ratios that are different than the aspect ratio of the display area, resulting in the possibility of blank portions on at least part of the screen. By way of another example, a particular device 104 may be designed or configured to leave a small unused portion around the border of the display area.

The interactive advertisement overlays generated by device 102 overlay the full-screen program content and/or video commercial content displayed on display device 104. The user can also interact with the overlay, commanding the overlay to be displayed and/or removed at any time, as well as changing the overlay panels being displayed. When the overlay is being presented, the user can interact with the overlay but cannot interact with the program content and/or video commercial content that the overlay covers. An advertisement overlay can be any of a variety of different shapes and sizes, and can be located in any position on the full-screen display of device 104.

The overlay is situated “on top” of the program and/or video commercial content, and as such can be referred to as covering or being on the program and/or video commercial content. The overlay is typically positioned to cover only a portion of the full-screen content, although alternatively the overlay could be positioned to cover the entirety of the full-screen content. The overlay can be transparent or opaque. An opaque overlay does not allow any of the program and/or video commercial content below it to be seen through the overlay. With a transparent overlay, however, the display of the overlay is combined with the display of the underlying program and/or video commercial content so that some of both can be seen. This combining can be done in any of a variety of conventional manners. The amount of the underlying program and/or video commercial content that can be seen through the overlay can vary depending on the amount or degree of transparency of the overlay. Additionally, different portions of the overlay can have different amounts of transparency. For example, the overlay could include a middle portion that is opaque and areas that are closer to the edge of the overlay could be more transparent.

An advertisement overlay includes different overlay panels. Each overlay panel typically displays different advertisement information to the user, although alternatively some overlay panels can contain duplicate information. Any type of information can be included in an overlay panel, such as text, graphics, audio data to be played back audibly, images, video content, links to network (e.g., Internet) locations, and so forth. The user is able to interact with the overlay to change which overlay panel is being displayed, such as by using one or more arrow or directional keys on a remote control device to scroll through the different panels, entering an alphanumeric identifier of a particular panel to jump directly to that panel, and so forth. The user can interact with the overlay using any of a variety of different user input devices, such as a remote control (e.g., a television or universal remote control), a keyboard, a mouse or track pad or other cursor control device, an input mechanism of device 102 or display device 104 (e.g.; directional arrows, a numeric keypad, etc.), and so forth.

The advertisement overlay can be, but need not be, tied to the video commercial content that it overlays. For example, the advertisement overlay can include further details or information regarding a product or service being advertised in the video commercial it overlays. The advertisement overlay can also be coordinated with the video commercial content it overlays, allowing the user to input various information such as cast a vote, fill out a survey, and so forth. Such coordination between the interactive advertisement overlay and the video commercial content allows the user to interact with the advertisement overlay and at the same time feel as if he or she is interacting with the video commercial it overlays.

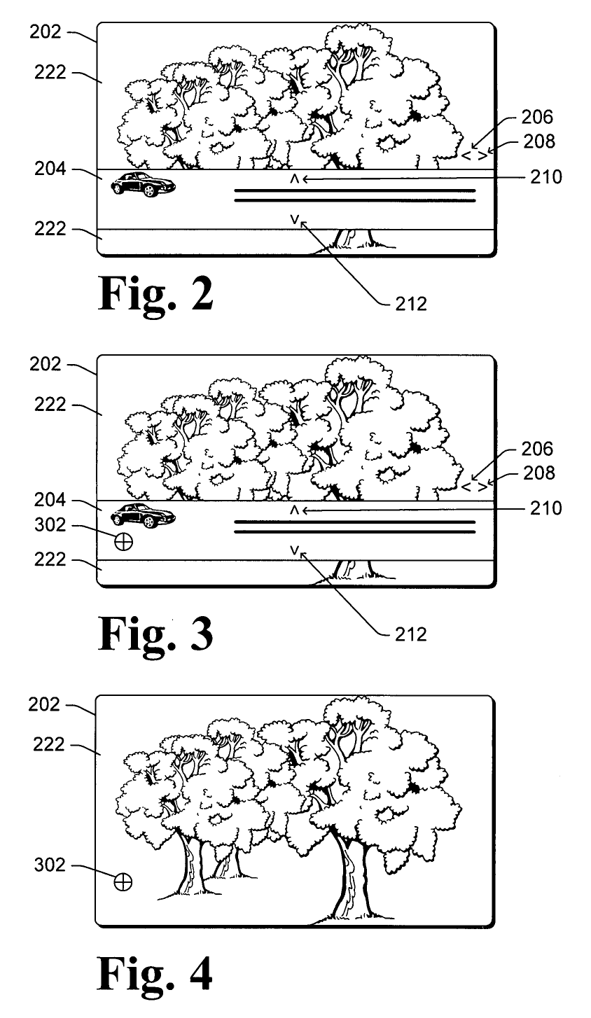

FIG. 2 illustrates an example overlay on a full-screen display. As shown in FIG. 2, a full-screen display 202 includes a portion 222 displaying program and/or video commercial content, and also includes an interactive advertisement overlay 204. As shown, part of portion 222 is located on display 202 vertically above overlay 204, while another part of portion 222 is located on display 202 vertically below overlay 204. Advertisement overlay 204 is situated on top of the program and/or video commercial content, and includes an interactive advertisement (typically an advertisement for a sponsor of the program content being displayed in portion 222). Advertisement 204 as illustrated includes an image of a vehicle, as well as several lines of descriptive text. Advertisement overlay 204 is illustrated as being opaque in FIG. 2, although overlay 204 can alternatively having varying amounts of transparency.

Associated with advertisement overlay 204 are arrows 206, 208, 210, and 212. Left arrow 206 and right arrow 208 indicate to a user that advertisement overlay 204 includes multiple overlay panels, and that the user can use left and right arrows on a remote control device to change the display in overlay 204 to a different panel. Up arrow 210 and down arrow 212 indicate to a user that the current overlay panel being displayed has additional information that can be displayed, and the user can scroll through this additional information by selecting up and down arrows on the remote control device.

It is to be appreciated that FIG. 2 illustrates only an example of an overlay on a full-screen display. Overlay 204 could be located in any position on display 202 and can have any shape (e.g., rectangular, square, circular, hexagonal, and so forth). Additionally, overlay 204 can be any size, including being smaller than illustrated in FIG. 2 or being larger.

The user can interact with advertisement overlay 204 in different manners. For example, arrows 206 or 208 can be selected to have different overlay panels displayed, and arrows 210 and 212 can be selected to have different information for a particular panel displayed. By way of another example, an overlay panel may include a link that can be selected by the user to cause a network location to be accessed (e.g., by device 102 of FIG. 1) and information obtained from that location retrieved and displayed in overlay 204 (e.g., a link to a web page that can be displayed in the panel). By way of yet another example, an overlay panel may include user input fields, such as text entry fields, lists of items that can be highlighted or otherwise selected, and so forth to allow the user to input data.

Returning to FIG. 1, the ad icons displayed on device 104 are small icons, sometimes referred to as bugs, that serve as an advertisement of a sponsor of program content. The sponsor of program content is, for example, any company or other entity that has provided financial funding for creation and/or distribution of the program content. Video commercial content for the sponsor of program content can also be displayed to the user on device 104, although an ad icon can also be displayed for a sponsor for which no commercial content is displayed.

An ad icon is typically transparent, although the degree of transparency can vary by implementation, analogous to the transparency of the overlay discussed above. Alternatively, the ad icon can be opaque. The ad icon is situated “on top” of the program and/or video commercial content, and as such can be referred to as covering or being on the program and/or video commercial content. The ad icon can also be situated “on top” of the advertisement overlay, and as such can be referred to as covering or being on the advertisement overlay. The ad icon is typically smaller than an overlay, and typically does not have multiple panels.

The ad icon can be positioned anywhere on the full-screen display, including over program content, over video commercial content, over an advertisement overlay, and so forth. The ad icon can also have any shape, and oftentimes is a graphical image associated with a sponsor (e.g., an image or trademark commonly associated with a particular sponsor). The ad icon is interactive in that it can be selected by the user in any of a variety of manners, such as a remote control (e.g., a television or universal remote control), a keyboard, a mouse or track pad or other cursor control device, an input mechanism of device 102 or display device 104 (e.g., directional arrows, a numeric keypad, etc.), and so forth. The advertisement overlay can be displayed in response to user selection of the ad icon, as discussed in more detail below.

FIG. 3 illustrates another example overlay with an ad icon on a full-screen display FIG. 3 illustrates a full-screen display 202 of program and/or video commercial content in a portion 222 and includes an overlay 204, as well as arrows 206, 210, and 212 as discussed above with respect to FIG. 2. Additionally, FIG. 3 illustrates an ad icon 302 that is positioned over a portion of overlay 204.

It is to be appreciated that FIG. 3 illustrates only an example of an overlay with an ad icon on a full-screen display. Ad icon 302 could be located in any position on display 202, including over areas where overlay 204 does not cover display 202. Ad icon 302 can also have any shape (e.g., rectangular, square, circular, hexagonal, and so forth), and can also be a graphical image. Additionally, ad icon 302 can be any size, including being smaller than illustrated in FIG. 3 or being larger.

FIG. 4 illustrates another example ad icon on a full-screen display. FIG. 4 illustrates a full-screen display 202 of program and/or commercial content in a portion 222 and ad icon 302 as discussed above with respect to FIG. 3. In FIG. 4, however, no overlay is displayed. Ad icon 302 is displayed in the same location as ad icon 302 in FIG. 3, although alternatively the ad icons can be displayed in different locations.

Returning to FIG. 1, device 102 includes a player module 112, advertising module 114, and tracking module 116. Player module 112 coordinates the full-screen playback of program content and video commercial content on display device 102. In one or more embodiments, video commercial content 106 is received embedded in the program content 106. The video commercial content is embedded typically by the program content distributor, and is typically interspersed throughout the program content. For example, after every 7-10 minutes of program content playback, a 1-2 minute commercial block including one or more commercials is embedded. This is the traditional program content with interspersed commercials that television viewers have grown accustomed to.

Player module 112 may optionally include various navigational controls to navigate through program content and video commercial content. For example, a user may be able to pause playback of the program and/or video commercial content, fast forward through the content, rewind the content, and so forth. These navigational controls can be implemented in different manners, such as by storing content 106 and/or 108 on a storage device of device 102 (or other storage device accessible to device 102), by returning navigational commands to the source of content 106 and/or 108, and so forth.

Advertising module 114 controls the display of interactive advertisement information that is to be displayed on device 104, including both the advertisement content that is included in advertisement overlays and the ad icons that are displayed. Each sponsor typically provides to device 102 the advertisement information that they would like displayed, which can include the particular icon that is to be displayed as the ad icon. This information is typically stored in a storage component of, or accessible to, device 102. The advertisement information can be made available in any of a variety of different manners. For example, the advertisement information could be sent directly to device 102 by a sponsor's device, the advertisement information could be accessed from a remote server by advertising module 114, the advertisement information could be included as part of content 106 (e.g., in a vertical blanking interval (VBI), as a separate channel, etc.), and so forth. The commercial information that is displayed in the interactive advertisement overlay can be received in the same manner from the same source as the video commercial content, or alternatively in a different manner and/or from a different source.

It should be noted that the interactive ad icons and the interactive advertisement overlays displayed for different sponsors are typically different. Additionally, the advertisement overlays and ad icons for the same sponsor can be the same, or alternatively can change over time. Furthermore, it should be noted that there need not be any correlation between the sponsor of a displayed ad icon or ad overlay, and the sponsor of displayed video commercial content. When video commercial content is being displayed, the ad icon and/or ad overlay being displayed can be for the same sponsor as the video commercial content, or alternatively a different sponsor.

In one or more embodiments, tracking module 116 is included in device 102 and tracks how the user interacts with the advertisement overlays and/or the ad icons. Any of the user's interactions with the overlay and/or the icon can be tracked, such as selection of the ad icon (and when during playback of content 106 the selection was made), scrolling through additional information on a panel of the overlay, selecting a different panel in the overlay, an amount of time the overlay was displayed, an amount of time particular panels on the overlay were displayed, and so forth. Thus, the tracked information describes how a user actually interacted with the advertisement information.

Any of this tracked information is maintained by device 102 and can be returned directly or indirectly to the sponsor. For example, a service provider may collect the information on behalf of various sponsors and return the tracked information for each sponsor's advertisements to that sponsor. This return of information can optionally be performed only with the permission of the user of device 102. Additionally, a fee may optionally be charged (e.g., by the service provider) to the sponsor for this information.

Alternatively, tracking of the user's interaction with the overlays and/or the as icons may not be performed, in which case tracking module 116 need not be included in device 102.

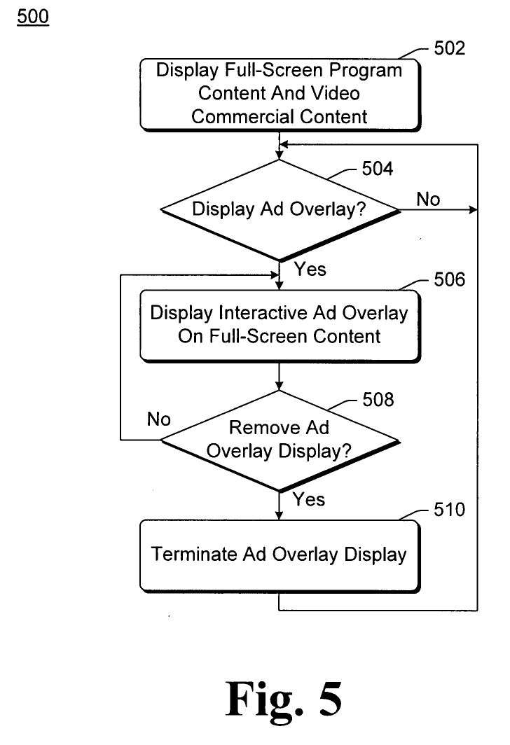

FIG. 5 is a flowchart illustrating an example process 500 for displaying an interactive advertisement overlay. Process 500 is carried out by a device, such as device 102 of FIG. 1, and can be implemented in software, firmware, hardware, or combinations thereof.

Initially, full-screen program content and/or video commercial content is displayed (act 502). A determination is then made as to whether an advertisement overlay is to be displayed (act 504). This determination in act 504 can be made in any of a variety of different manners. In some situations the determination can be made to automatically display the advertisement overlay without any user action (e.g., independent of any user request to display the overlay). In other situations, the determination can be made to display the advertisement overlay in response to a user request to do so.

In one or more embodiments, an indication of when the advertisement overlay is to be displayed is embedded in the program content and/or video commercial content (e.g., the content may include an indication that the advertisement overlay is to be displayed during the display of video commercial content). In alternate embodiments, the determination of when to display the advertisement overlay can be made in different manners. For example, the advertisement overlay can be displayed whenever the ad icon is selected by the user. The ad icon can be selected by the user in different manners, such as by navigating a pointer over the icon and pressing a button on a remote control device or other cursor control device, by pressing a button associated with the icon on a remote control device (e.g., the icon may be a directional arrow and the user can press a directional arrow button on the remote control device that is in the same direction as the icon), and so forth.

The determination of when to display the advertisement overlay can also be made in various other manners. For example, the advertisement overlay can be displayed at regular or irregular intervals during playback of the program and/or video commercial content. By way of another example, the advertisement overlay can be displayed at the beginning of the display of program content (e.g., during the first minute of a television program), at the ending of the display of program content (e.g., during the last minute of a television program), and so forth. By way of yet another example, the advertisement overlay can be displayed whenever a remote control device is picked up or otherwise moved by the user (e.g., a sensor in the remote control device can be used to indicate when the remote control device is stationary or moving, or alternatively can be used to indicate when the remote control device is set down), or whenever a particular button on the remote is pressed by the user.

Once it is determined that an advertisement overlay is to be displayed, an interactive advertisement overlay is displayed on the full-screen content (act 506). In one or more embodiments, a single advertisement overlay is made available to the device at any given time, and that single advertisement overlay is displayed in act 506. Alternatively, multiple advertisement overlays may be available to the device at any given time. If multiple advertisement overlays are available, then an identifier can be used to select which overlay to display. For example, an identifier of a particular overlay may be embedded in the program content and/or video commercial content. By way of another example, different advertisement overlays may correspond to different sponsors. In this example, an identifier of a particular sponsor may be embedded in the program content and/or video commercial content (or may be otherwise provided to the device), and this identifier can be used to identify the corresponding advertisement overlay. By way of yet another example, different advertisement overlays may correspond to different portions of the program content and/or video commercial content, so which advertisement overlay is displayed is dependent on which portion of the program content and/or video commercial content is being displayed at the time it is determined that the advertisement overlay is to be displayed in act 504.

A check is then made as to whether the display of the advertisement overlay is to be removed or terminated (act 508). When the advertisement overlay is to be removed or terminated can be determined in any of a variety of different manners. In one or more embodiments, an indication of when the advertisement overlay is to be removed is embedded in the program content and/or video commercial content (e.g., the content may include an indication that the display of the advertisement overlay is to be removed at the end of the display of video commercial content). In alternate embodiments, the determination of when to remove the display of the advertisement overlay can be made in different manners. For example, the advertisement overlay display can be removed after a particular amount of time (e.g., 30 seconds). The advertisement overlays can optionally be displayed for a constant amount of time, or alternatively the duration of the display can be a variable amount of time. By way of another example, the display of the advertisement overlay can be removed when a remote control device is set down by the user (e.g., a sensor in the remote control device can be used to indicate when the remote control device is stationary or moving, or alternatively can be used to indicate when the remote control device is set down), whenever a particular button on the remote (e.g., a “back” button) is pressed by the user, whenever a particular key on a keyboard (e.g., the escape (esc) key) is pressed by the user, and so forth.

The advertisement overlay display remains until it is determined in act 508 that it is to be removed. Once the determination is made that the display of the advertisement overlay is to be removed, the display of the advertisement overlay is terminated (act 510). The advertisement overlay is no longer displayed on the full-screen content until a determination is again made in act 504 to display the advertisement overlay, at which point the advertisement overlay is re-displayed.

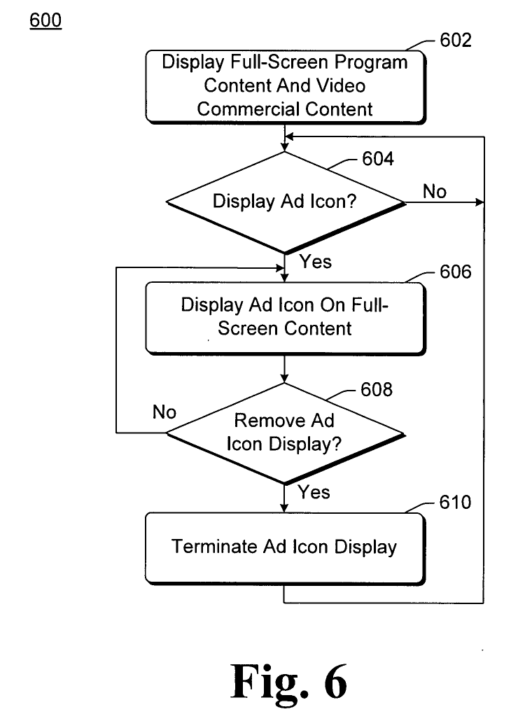

FIG. 6 is a flowchart illustrating an example process 600 for displaying an ad icon. Process 600 is carried out by a device, such as device 102 of FIG. 1, and can be implemented in software, firmware, hardware, or combinations thereof.

Initially, full-screen program content and/or video commercial content is displayed (act 602). A determination is then made as to whether an ad icon is to be displayed (act 604). This determination in act 604 can be made in any of a variety of different manners. In one or more embodiments, an indication of when the ad icon is to be displayed is embedded in the program content and/or video commercial content. For example, the content 106 may include an indication that the ad icon is to be displayed five seconds before the display of video commercial content is to begin, that the ad icon is to be displayed during the video commercial content, that the ad icon is to be displayed for ten seconds after the display of video commercial content ends, and so forth.

In alternate embodiments, the determination of when to display the ad icon can be made in different manners. For example, the ad icon can be displayed at regular or irregular intervals during playback of the program and/or video commercial content. By way of another example, the ad icon can be displayed at the beginning of the display of program content (e.g., during the first minute of a television program), at the ending of the display of program content (e.g., during the last minute of a television program), and so forth. By way of yet another example, the ad icon can be displayed whenever a remote control device is picked up or otherwise moved by the user (e.g., a sensor in the remote control device can be used to indicate when the remote control device is stationary or moving, or alternatively can be used to indicate when the remote control device is set down), or whenever a particular button on the remote is pressed by the user.

Once it is determined that an ad icon is to be displayed, the ad icon is displayed on the full-screen content (act 606). In one or more embodiments, a single ad icon is made available to the device at any given time, and that single ad icon is displayed in act 606. Alternatively, multiple ad icons may be available to the device at any given time. If multiple ad icons are available, then an identifier can be used to select which ad icon to display. For example, an identifier of a particular ad icon may be embedded in the program content and/or video commercial content. By way of another example, different ad icons may correspond to different sponsors. In this example, an identifier of a particular sponsor may be embedded in the program content and/or video commercial content (or may be otherwise provided to the device), and this identifier can be used to identify the corresponding ad icon.

A check is then made as to whether the display of the ad icon is to be removed or terminated (act 608). When the ad icon is to be removed or terminated can be determined in any of a variety of different manners. In one or more embodiments, an indication of when the ad icon is to be removed is embedded in the program content and/or video commercial content (e.g., a duration for display of the ad icon may be included in the program content and/or video commercial content, or a “terminate” indicator may be included in the program content and/or video commercial content to indicate that the display of the ad icon should be terminated). In alternate embodiments, the determination of when to remove the display of the ad icon can be made in different manners. For example, the ad icon display can be removed after a particular amount of time (e.g., 30 seconds). The ad icons can optionally be displayed for a constant amount of time, or alternatively the duration of the display can be a variable amount of time. By way of another example, the display of the ad icon can be removed when a remote control device is set down by the user (e.g., a sensor in the remote control device can be used to indicate when the remote control device is stationary or moving, or alternatively can be used to indicate when the remote control device is set down), or whenever a particular button on the remote is pressed by the user.

The ad icon display remains until it is determined in act 608 that it is to be removed. Once the determination is made that the display of the ad icon is to be removed, the display of the ad icon is terminated (act 610). The ad icon is no longer displayed on the full-screen content until a determination is again made in act 604 to display the ad icon, at which point the ad icon is re-displayed.

The ability to display advertisement overlays at different times during the display of full-screen program and/or video commercial content, as well as the ability to display ad icons at different times during the display of full-screen program and/or video commercial content, provides numerous usage scenarios. For example, ad icons can be displayed at what are deemed to be strategic times, such as for several seconds before display of video commercial content begins, or for several seconds after the display of video commercial content has ended (and display of the program content has resumed). Displaying ad icons at such times can provide an indication to the user that additional advertisement information is available and can be accessed by selecting the displayed ad icon. Furthermore, the user has it within his or her control to bring up advertisement content, as well as watch video commercials, at times of his or her choosing.

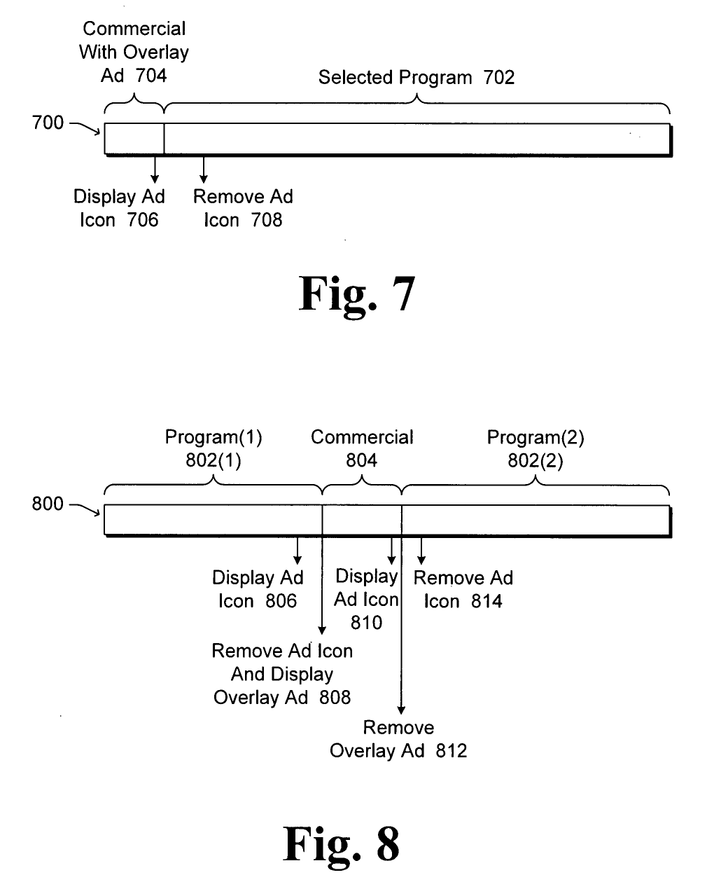

FIG. 7 illustrates an example timeline display 700 of program playback with an advertisement overlay and ad icons. In the example of FIG. 7, assume that a user has selected a particular program 702 for playback. Prior to playback of the selected program 702, video commercial content and an advertisement overlay 704 is displayed to the user. This video commercial content can be, for example, a cover page identifying the sponsor of selected program 702, a traditional 30-second or 60-second commercial for the sponsor of selected program 702, etc. Several seconds before the display of the video commercial content and advertisement overlay 704 ends, an ad icon is displayed 706. This ad icon remains displayed for several seconds into the display of selected program 702, after which the ad icon is removed 708. Keeping the ad icon displayed after the video commercial and advertisement overlay display 704 has ended allows an icon representing the sponsor to remain displayed to the user, and allows the user to select that icon in order to obtain additional information regarding the sponsor by bringing back the advertisement overlay.

It is to be appreciated that FIG. 7 is an example of program playback with an advertisement overlay and ad icons, and that various modifications can be made to the timeline illustrated. For example, the video commercial content 704 may be displayed but without the overlay ad. By way of another example, the ad icon may not be displayed at 706, but displayed at the beginning of the display of the selected program 702. By way of still another example, the ad icon may be displayed again several seconds before the display of the selected program 702 ends, or during the of the program credits at the end of program 702.

FIG. 8 illustrates another example timeline display 800 of program playback with an advertisement overlay and ad icons. In the example of FIG. 8, assume that a user has selected a particular program 802 for playback. The selected program 802 is displayed in two parts, 802(1) and 802(2) separated by video commercial content 804. Several seconds before the display of the first part of the selected program 802(1) ends, an ad icon is displayed 806. The ad icon remains displayed until display of the video commercial content 804 begins, at which point the as icon is removed and the advertisement overlay is displayed 808. Several seconds before the display of the video commercial content 804 ends, the ad icon is again displayed 810. At the end of the video commercial content 804, the advertisement overlay display is removed 812, but the ad icon remains displayed. The ad icon remains displayed for several seconds into the display of the second part of the selected program 802(2), after which the ad icon is removed 814.

It is to be appreciated that FIG. 8 is an example of program playback with ad advertisement overlay and ad icons, and that various modifications can be made to the timeline illustrated. For example, the ad icon may not be displayed at 806 but still displayed at 810. By way of another example, the ad icon may be displayed at 806 but not at 810. By way of still another example, the ad icon may be displayed again several seconds before the display of the second part of the selected program 802(2) ends.

It should also be noted that although FIGS. 7 and 8 illustrate example timelines when advertisement overlays and icons can be displayed and removed, the advertisement overlays and/or icons can also be displayed and removed at different times under the control of the user. As discussed above, through various actions the user is able to have the advertisement overlays and/or icons displayed and removed, and such display and removal is performed in addition to the display and removal illustrated in FIGS. 7 and 8.

FIGS. 7 and 8 are discussed with reference to time durations of “several seconds” in different locations (e.g., ad icon being displayed 706 several seconds before the display of the video commercial content and advertisement overlay 704 ends). It is to be appreciated that these amounts of time can vary by implementation, and that any amounts of time can be used. Additionally, different amounts of time can be used at different locations along timelines 700 and 800. For example, “several seconds” may be implemented as 5 seconds at one location, and 120 seconds at another location.

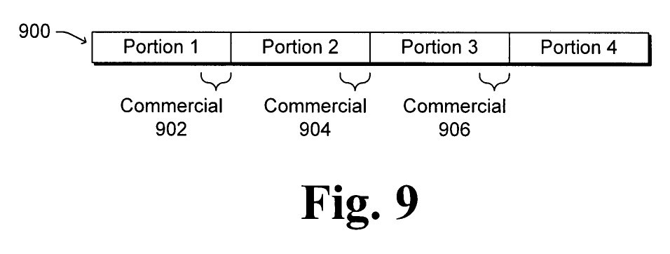

FIG. 9 illustrates another example timeline display 900 of program playback with advertisement overlays. In the example of FIG. 9, assume that a user has selected a particular program associated with timeline 900 for playback. The selected program includes four portions, labeled as portion 1, portion 2, portion 3, and portion 4. During normal playback of the program associated with timeline 900, a video commercial would be played back at the end of each of portions 1, 2, and 3, shown as video commercials 902, 904, and 906. In one or more embodiments, however, the advertisement overlay can be used to alter the timeline and the playback of video commercial content. If the user does not use the advertisement overlay to alter the timeline, then display of the video commercial content is made at the end of each of portions 1, 2, and 3.

However, the advertisement overlay can include multiple panels, one of which can identify the video commercial content that would be played back at the end of portion 1, another of which can identify the video commercial content that would be played back at the end of portion 2, and another of which can identify the video commercial content that would be played back at the end of portion 3. The user can interact with the advertisement overlay and select to view the video commercial content prior to the end of portion 1, 2, and/or 3. During such viewing of the video commercial content, playback of the program content would be paused so that full-screen display of the video commercial content can be displayed. For example, the advertisement overlay can include links to sources for the video commercial content that can be selected by the user. Once particular video commercial content has been displayed to the user, a record that this video commercial content has been displayed can be maintained (e.g., by advertising module 114 of FIG. 1), and the video commercial content need not be played back at the time normally scheduled in timeline 900.

For example, assume that at the very beginning of timeline 900 the advertisement overlay is displayed and the user selects to display video commercial 902 and video commercial 904. These commercials are accessed by advertising module 114 of FIG. 1 (e.g., from a server on the Internet, from a local storage device, etc.) and displayed to the user. Advertising module 114 keeps track of each video commercial displayed, and if video commercials 902 and 904 are displayed in their entirety, the user can watch the remainder of portion 1 as well as portion 2 and portion 3 without commercial interruption. However, at the end of portion 3, video commercial 906 is displayed to the user because the user did not select to display video commercial 906 from the advertisement overlay, after which portion 4 is displayed to the user.

In one or more embodiments, advertising module 114 of FIG. 1 maintains a record of these displayed video commercials associated with this selected program for a period of time (e.g., several days, or until the record should be deleted to make room for newer records for more recently displayed programs). Thus, if the user watches the program again on a different day (or at a later time on the same day), the user need not watch the video commercials again as they have already been displayed to the user. However, links to the video commercials are still included in the advertisement overlay, so the user can still go back and watch the video commercials if desired.

The advertisement overlay can also include an advertisement credits panel, which is a list or summary of the video commercials 902, 904, and 906. The user can select a particular video commercial(s) from this panel to have that selected video commercial(s) displayed again to the user.

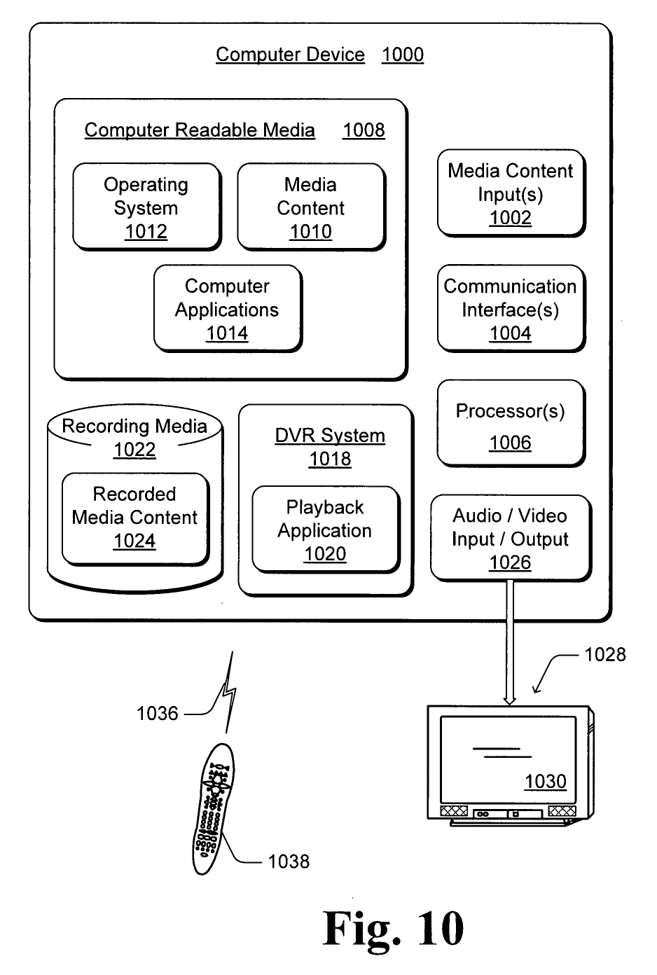

FIG. 10 illustrates various components of an example computer-based device 1000 that can be implemented as any form of a computing, electronic, appliance, or television client device to implement embodiments of the interactive advertisement overlays on full-screen content discussed herein. For example, device 1000 can be device 102 of FIG. 1. In various embodiments, computer device 1000 can be implemented as any one or combination of a television client device, a desktop computer, a portable computer, an appliance device, a gaming console, and/or as any other type of computing-based device.

Computer device 1000 includes one or more media content inputs 1002 that may include Internet Protocol (IP) inputs over which streams of media content are received via an IP-based network, satellite transmission inputs, radio frequency transmission inputs, cable transmission inputs, and/or any number of other wired or wireless transmission media inputs. Computer device 1000 further includes communication interface(s) 1004 that can be implemented as any one or more of a serial and/or parallel interface, a universal serial bus (USB) interface, a wireless interface, any type of network interface, a modem, and as any other type of communication interface. A wireless interface enables client device 1000 to receive control input commands 1036 and other information from an input device, such as from remote control device 1038, or from a portable computing-based device (such as a cellular phone), or from another infrared (IR), 802.11, Bluetooth, or similar RF input device.

A network interface provides a connection between computer device 1000 and a communication network by which other electronic and computing devices can communicate data with device 1000. Similarly, a serial, parallel, and/or USB interface provides for data communication directly between computer device 1000 and the other electronic or computing devices. A modem facilitates computer device 1000 communication with other electronic and computing devices via a conventional telephone line, a DSL connection, cable, and/or other type of connection.

Computer device 1000 also includes one or more processors 1006 (e.g., any of microprocessors, controllers, and the like) which process various computer-executable instructions to control the operation of device 1000, to communicate with other electronic and computing devices, and to implement embodiments of an on-screen keyboard. Computer device 1000 can be implemented with computer readable media 1008, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 1008 provides data storage mechanisms to store media content 1010, such as the program and/or commercial content discussed above. Computer readable media 1008 also provides data storage mechanisms to store other information and/or data such as software applications and any other types of information and data related to operational aspects of computer device 1000. For example, an operating system 1012 and/or other computer applications 1014 can be maintained as software applications with the computer readable media 1008 and executed on processor(s) 1006 to implement embodiments of an on-screen keyboard. Examples of such other computer applications include player module 112, advertising module 114, and/or tracking module 116 of FIG. 1.

When implemented as a television client device, the computer device 1000 can also include a DVR system 1018 with playback application 1020, and recording media 1022 to maintain recorded media content 1024 that computer device 1000 receives and/or records. Further, computer device 1000 may access or receive additional recorded media content that is maintained with a remote data store (not shown). Computer device 1000 may also receive media content from a video-on-demand server, or media content that is maintained at a broadcast center or content distributor that distributes the media content to subscriber sites and client devices. The playback application 1020 can be implemented as a video control application to control the playback of media content 1010, the recorded media content 1024, and/or other video on-demand media content, music, and any other audio, video, and/or image media content which can be rendered and/or displayed for viewing.

Computer device 1000 also includes an audio and/or video output 1026 that provides audio and/or video data to an audio rendering and/or display system 1028. The audio rendering and/or display system 1028 can include any devices that process, display, and/or otherwise render audio, video, and image data. Video signals and audio signals can be communicated from computer device 1000 to a display device 1030 via an RF (radio frequency) link, S-video link, composite video link, component video link, DVI (digital video interface), analog audio connection, or other similar communication link. Alternatively, the audio rendering and/or display system 1028 can be implemented as integrated components of the example computer device 1000.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer storage media having stored thereon instructions that, when executed by one or more processors of a device, cause the one or more processors to:
display an interactive advertisement overlay on a full-screen display of video commercial content;
at the end of display of the video commercial content, terminate the display of the interactive overlay and display an ad icon during a full-screen display of program content; and
re-display the interactive advertisement overlay in response to user selection of the ad icon.

2. One or more computer storage media as recited in claim 1, the interactive advertisement overlay including a link to the video commercial content, selection of the link causing display of the program content to be paused to allow the video commercial content to be displayed.

3. One or more computer storage media as recited in claim 1, the interactive advertisement overlay including multiple overlay panels that a user can navigate through to obtain advertising information regarding a sponsor of the program content.

4. One or more computer storage media as recited in claim 1, the instructions further causing the one or more processors to remove the ad icon from the full-screen display after the ad icon has been displayed for an amount of time.

5. One or more computer storage media as recited in claim 4, the instructions further causing the one or more processors to determine, after the ad icon has been removed from the full-screen display, that the ad icon is to be displayed, and re-displaying the ad icon on the full-screen display when it is determined that the ad icon is to be displayed.

6. A method comprising:
displaying program content and video commercial content on a full-screen display of a display device; and
displaying an interactive advertisement overlay on the full-screen display, the interactive advertisement overlay including advertising information associated with a sponsor of the program content.

7. A method as recited in claim 6, further comprising:
displaying an ad icon on the full-screen display;
keeping the ad icon displayed on the full-screen display after display of the interactive advertisement overlay has been terminated;
receiving a user selection of the ad icon; and
re-displaying the interactive advertisement overlay in response to the user selection.

8. A method as recited in claim 7, wherein displaying the ad icon on the full-screen display comprises displaying the ad icon while the interactive advertisement overlay is being displayed on the full-screen display.

9. A method as recited in claim 7, further comprising:
determining that the ad icon has been displayed for a particular amount of time; and
removing the ad icon from the full-screen display in response to the ad icon having been displayed for the particular amount of time.

10. A method as recited in claim 9, further comprising:
re-displaying the ad icon on the full-screen display in response to a remote control device being moved.

11. A method as recited in claim 6, the interactive advertisement overlay including a link to the video commercial content, the method further comprising:
receiving a user-selection of the link;
displaying, in response to the user-selection, the video commercial content on the full-screen display; and
continuing displaying the program content after the video commercial content has been displayed, skipping displaying the video commercial content when the video commercial content would otherwise have been displayed had the user-selection not been received.

12. A method as recited in claim 6, the interactive advertisement overlay including multiple overlay panels that a user can navigate through to obtain advertising information regarding a sponsor of the program content.

13. A method as recited in claim 12, one of the multiple overlay panels including an advertisement credits panel that lists different video commercials in the video commercial content.

14. A method as recited in claim 6, further comprising:
tracking a user's interaction with the interactive advertisement overlay; and
maintaining tracking information describing the user's interaction with the interactive advertisement overlay.

15. A method as recited in claim 14, further comprising:
sending the tracking information to the sponsor in exchange for a fee.

16. A device comprising:
a player module to display program content and video commercial content on a full-screen display of a display device; and
an advertising module to display, independent of any user request for display of an interactive advertisement overlay, advertisement information in the interactive advertisement overlay on the full-screen display, the interactive advertisement overlay being displayed over one or both of the program content and the video commercial content.

17. A device as recited in claim 16, the device comprising the display device.

18. A device as recited in claim 16, further comprising:
a tracking module to track a user's interaction with the interactive advertisement overlay, and maintain tracking information describing the user's interaction with the interactive advertisement overlay.

19. A device as recited in claim 16, wherein the advertising module is further to determine that the interactive advertisement overlay is to be displayed in response to a user request to display the interactive advertisement overlay, and to display the advertising information in the interactive advertisement overlay in response to the user request.

20. A device as recited in claim 19, wherein the advertising module is further to display an ad icon on the full-screen display, and wherein the user request is a user selection of the ad icon.
